(19) United States
(12) Patent Application Publication
(10) Pub. No.: US 2026/0227990 A1
(43) Pub. Date: Aug. 6, 2026

(54) CONTROLLING UPDATE OF INSTRUCTION SETS WITHIN APPLICATIONS USING IDENTIFIERS

(71) Applicant: International Business Machines Corporation, Armonk, NY (US)

(72) Inventors: Heng Wang, Changping District (CN); Yu Zui You, Ningbo (CN); Xiao Ling Chen, Changping District (CN); Zhan Peng Huo, Changping District (CN)

(21) Appl. No.: 19/045,774

(22) Filed: Feb. 5, 2025

(51) Int. Cl. G06F 8/65

(52) U.S. Cl. CPC G06F 8/65

(57) ABSTRACT

Controlling update of instruction sets based on identifiers includes retrieving a first identifier associated with a first instruction set. The first instruction set is deployed within an application hosted on one of a cloud platform or an electronic device. A second identifier associated with a second instruction set is retrieved. The second instruction set is hosted on the cloud platform. The first identifier and the second identifier are analyzed. It is determined that the first identifier is different from the second identifier. The second instruction set is retrieved from cloud platform based on the determination that the first identifier is different from the second identifier. The application is updated based on the retrieved second instruction set. The update of the application corresponds to a replacement of the first instruction set within the application with the second instruction set. Further, the updated application is outputted.

### BACKGROUND

The disclosure relates to applications executable in a computational environment and more particularly, to controlling the update of the applications.

In software development, applications like Open Secure Shell (OpenSSH) and Open Secure Sockets Layer (OpenSSL) play a significant role in securing communications and protecting data through cryptographic algorithms. The cryptographic algorithms are foundational for ensuring data confidentiality, integrity, and authenticity. As technology evolves, the reliance on robust cryptographic methods becomes increasingly vital to protect sensitive information against potential threats. However, a landscape of cybersecurity is continuously changing, with new vulnerabilities frequently evolving. This dynamic environment requires regular updates and patches to address security flaws in software applications. As computational power increases and cryptanalysis processes advance, the existing cryptographic algorithms need to evolve, ensuring that they remain resilient against emerging threats.

### SUMMARY

In various embodiments of the disclosure, a computer-implemented method for controlling an update of instruction sets within applications using identifiers is described. The computer-implemented method includes retrieving, by a computer, a first identifier associated with a first instruction set. The first instruction set is deployed within an application hosted on one of a cloud platform or an electronic device. The computer-implemented method includes retrieving, by the computer, a second identifier associated with a second instruction set, the second instruction set is hosted on the cloud platform. The second instruction set is associated with the first instruction set. The computer-implemented method includes analyzing, by the computer, the first identifier and the second identifier. The computer-implemented method includes determining, by the computer, the first identifier is different from the second identifier based on the analysis. The computer-implemented method includes retrieving, by the computer, the second instruction set from the cloud platform based on the determination that the first identifier is different from the second identifier; The computer-implemented method includes updating, by the computer, the application based on the retrieved second instruction set. The updating of the application corresponds to a replacement of the first instruction set within the application with the second instruction set. The computer-implemented method includes outputting, by the computer, the updated application.

In various embodiments of the disclosure, a computer system for controlling the update of the instruction sets within the applications using the identifiers is described.

In various embodiments of the disclosure, a computer program product for controlling the update of the instruction sets within the applications using the identifiers is provided. The computer program product includes a computer-readable storage media having program instructions stored on the computer-readable storage media to perform operations. The operations include retrieving a first identifier associated with a first instruction set. The first instruction set is deployed within an application hosted on one of a cloud platform or an electronic device. The operations further include retrieving a second identifier associated with a second instruction set, the second instruction set is hosted on the cloud platform. The second instruction set is associated with the first instruction set. The operations further include analyzing the first identifier and the second identifier. The operations further include determining the first identifier is identical to the second identifier based on the analysis. The operations further include outputting the application based on the determination that the first identifier is identical to the second identifier.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for controlling an update of instruction sets within applications using identifiers, in accordance with an embodiment of the disclosure;

FIG. 2 is a diagram that illustrates an environment for controlling the update of the instruction sets within the applications using the identifiers, in accordance with an embodiment of the disclosure;

FIG. 3 is a diagram that illustrates a flowchart for controlling deployment of a second instruction set on a cloud platform based on a submission request, in accordance with an embodiment of the disclosure;

FIG. 4 is a block diagram that illustrates one or more operations for controlling the update of the instruction sets within the applications using the identifiers, in accordance with an embodiment of the disclosure;

FIG. 5 is a diagram that illustrates a flowchart for updating the application based on determination of a difference between a second identifier and a third identifier, in accordance with an embodiment of the disclosure;

FIG. 6 is a diagram that illustrates a flowchart for updating the application based on the determination of a difference between a fifth identifier and a sixth identifier, in accordance with an embodiment of the disclosure;

FIG. 7 is a diagram that illustrates a flowchart for updating the application based on determination of a difference between a fifth identifier and a sixth identifier, in accordance with an embodiment of the disclosure;

FIG. 8A is a diagram that illustrates an exemplary first user interface for controlling the update of the instruction sets within the applications using the identifiers, in accordance with an embodiment of the disclosure;

FIG. 8B is a diagram that illustrates an exemplary second user interface for controlling the update of the instruction sets within the applications using the identifiers, in accordance with an embodiment of the disclosure;

FIG. 9 illustrates a flowchart of a first exemplary method for controlling the update of the instruction sets within the applications using the identifiers, in accordance with an embodiment of the disclosure; and

FIG. 10 illustrates a flowchart of a second exemplary method for controlling the update of the instruction sets within the applications using the identifiers, in accordance with an embodiment of the disclosure.

### DETAILED DESCRIPTION

An algorithm is a step-by-by-step procedure or formula for solving a problem or performing a task. The algorithm includes sequence of well-defined instructions that can be executed to achieve an outcome. The algorithms can be expressed in various forms, such as programming languages. The algorithms are utilized in computational operations such as, but not limited to, data processing, calculations, security, and automated reasoning. The algorithms may be, but are not limited to, security algorithms, Artificial Intelligence (AI) algorithms, and Machine Learning (ML) algorithms. The security algorithms are mathematical methods and protocols designed to protect data and ensure secure communication in various digital environments. The digital environments are various online and electronic spaces where data is created, shared, stored, and processed. The digital environments may be, but are not limited to, cloud computing, web applications, and mobile applications. Various types of security algorithms include, but are not limited to, symmetric key algorithms, such as Advanced Encryption Standard (AES), which use same key for both encryption and decryption, and asymmetric key algorithms, such as Rivest-Shamir-Adleman (RSA), which utilize a pair of keys one public and one private to facilitate secure data exchange. Further, the AI algorithms are computational algorithms that enable a computer system to perform tasks that require human intelligence, such as learning, reasoning, and problem-solving. The AI algorithms are utilized to identify patterns within data, make predictions, or automate decision-making processes. The AI algorithms may be, but are not limited to, supervised learning algorithms, unsupervised learning algorithms, and reinforcement learning algorithms.

Recently, the rise of digital applications has changed how users and organizations operate. The digital applications utilize the algorithms such as the security algorithms, the AI algorithms, or the ML algorithms to function. The increased dependence on digital applications has led to a rise in cyber-threats, making application security an utmost concern. The cyber-threats include a range of malicious activities to compromise the digital applications, including malware, ransomware, phishing attacks, and data breaches. These cyber-threats exploit vulnerabilities in software and networks, leading to unauthorized access, data theft, and disruption of services, posing significant risks to the users and the organizations. Further, as attackers become more sophisticated, the algorithms that are utilized by the applications must be regularly updated to effectively counteract emerging threats. The attackers may be an individual or a group that engages in unethical activities using computers and the internet.

The landscape of the cyber-threats is constantly evolving. The attackers are using advanced processes such as artificial intelligence and machine learning to automate their attacks, making attacks faster and more efficient. For instance, automated bots can scan for vulnerabilities in the algorithms associated with the applications at an increased scale, identifying weaknesses that can be exploited.

As new features and functionalities are integrated into the applications, the new features and the functionalities can accidentally introduce vulnerabilities. The new features and the functionalities come with their own set of security challenges, necessitating a continuous reassessment and updating of the algorithms within the application.

Moreover, growing complexity of the applications, often involving multiple third-party services and Application Programming Interfaces (APIs), can lead to compromise in the application. When the users or the organizations integrate external components, they may accidentally introduce vulnerabilities that can be exploited by the attackers. This complexity highlights importance of regularly updating the algorithms to ensure that the application is always protected.

In conclusion, the increasing cyber-threats to the applications necessitate a proactive and dynamic approach to ensure the security of the applications. This helps in protecting the sensitive data within the application and staying up to date with the latest algorithms. By prioritizing the regular updating of the algorithms, the users and the organizations can create a more secure digital environment.

Traditional methods for updating the algorithms within the applications face significant challenges due to the computational complexity. The traditional methods for updating the algorithms are time-consuming and inefficient because developers of the applications must manually modify the algorithms within the applications. In the case of the application being hosted on a cloud platform, the developers associated with the algorithm need to constantly check the algorithms for security vulnerabilities manually and the developers associated with the applications need to check for the updates of the algorithms manually. The process of updating the algorithm within the application often involves extensive testing and validation from the developer's end to ensure that the updated algorithm integrates seamlessly without introducing new vulnerabilities within the applications. Traditional methods of automatically updating the application with the updated algorithm involve the application to constantly or periodically checking for the updated algorithm on a server where the updated algorithm is hosted. This constant or periodic check results in increased utilization of computational resources. For instance, a user device where the application is hosted checks for the updated application on the server at a first timestamp. Upon checking for the updated algorithm at the first timestamp, the user device determines that there is no updated algorithm on the server at the first timestamp. This results in a wastage of computational resources at the first timestamp. Further, in some cases, the server maintains a database where the server maintains a record of latest version of algorithms. When the user device sends a request to the server to check for the updated algorithm, the server parses through the database. This process is also computationally extensive.

Further, the traditional methods often face various challenges. The various challenges may be, but are not limited to, increased downtime of the applications. The increased downtime affects the availability of the applications. An additional challenge may be an increased risk of human error.

Further, manual implementation for updating the algorithm increases a likelihood of introducing the new vulnerabilities or bugs within the applications. The manual implementation requires additional processing power for compiling and testing the applications, especially where multiple iterations are vital to finalize the updated algorithm. In case the applications are not optimized during the update of the algorithms, it may lead to performance bottlenecks. Further, extensive testing and debugging of the algorithms update may lead to higher consumption of (Random Access Memory) RAM, potentially leading to slowdowns or failures. Further, the manual implementation may not utilize available memory, leading to suboptimal performance during the update of the algorithms. Further, in traditional methods, the developers often relied on third-party APIs to ensure the integrity of the updated algorithms. This reliance increased costs and added to the processing power mandatory, as the developers needed to share the data associated with the applications with the third parties. To overcome these challenges a more efficient method is disclosed for controlling an update of instruction sets (such as the security algorithms) within the applications.

The disclosed method controls the update of the instruction sets (such as the algorithms) within the applications using identifiers. The identifiers correspond to hash values associated with the corresponding instruction set. The disclosed method for updating the algorithms leverages a cloud-based platform to host and manage algorithms. In this approach, security auditors continuously monitor and update the algorithms on the cloud platform, ensuring that the latest security measures are always in place. The applications receive a notification regarding the updates of the algorithm, streamlining the process of integrating the updated algorithms with the applications. This eliminates the need for manual updating and testing by the developers, significantly reducing the time taken to implement the updates.

Once the update is made within the algorithm hosted on the cloud platform, it is automatically downloaded and installed within the applications, ensuring that the applications are consistently protected against emerging threats. The disclosed method determines that the algorithm is using a hash value. The usage of the hash value is relatively less computationally extensive than the manual checking for update or the server parsing through an entire database to check for the updates within the algorithm. The disclosed method enhances security and allows for real-time updates, enabling the organizations to respond quickly to the vulnerabilities. In a scenario, where the application is hosted on a local machine, the disclosed method optimizes resource allocation by offloading the algorithm updates to the cloud platform. The disclosed method allocates the processing power of the local machine to core application functions, enhancing overall performance of the applications. Further, as updates are managed on the cloud platform, the local machine is free from handling computational overhead associated with compilation and testing of the updated algorithms.

Further, as Central Processing Unit (CPU) utilization of the local machine is less due to the updates being handled over the cloud platform, the applications can maintain higher performance levels during peak usage times. Further, by reducing need for local storage of multiple versions of the algorithms, memory utilization is optimized, freeing up random access memory for various processes. The cloud-based approach allows the applications to maintain a smaller memory footprint, as the applications do not need to store extensive security update files locally, leading to improved responsiveness of the applications. With updates handled in the cloud platform, the applications can dynamically allocate memory based on current needs, rather than reserving space for potential updates, enhancing overall efficiency. Further, the disclosed method involves comparing hash values of the updated algorithm. The disclosed method compares the hash value of the updated algorithm obtained at the initiation of the updating process with the hash value obtained before the updated algorithm is about to be implemented within the application to verify the integrity of the updated algorithm, significantly reducing reliance on third-party services. By eliminating the need for external APIs, the disclosed method further reduces costs and processing power, while enhancing the overall security and performance of the applications.

In various embodiments of the disclosure, a computer-implemented method for controlling an update of instruction sets within applications using identifiers is described. The computer-implemented method includes retrieving, by a computer, a first identifier associated with a first instruction set. The first instruction set is deployed within an application hosted on one of a cloud platform or an electronic device. The computer-implemented method includes retrieving, by the computer, a second identifier associated with a second instruction set, the second instruction set is hosted on the cloud platform. The second instruction set is associated with the first instruction set. The computer-implemented method includes analyzing, by the computer, the first identifier and the second identifier. The computer-implemented method includes determining, by the computer, the first identifier is different from the second identifier based on the analysis. The computer-implemented method includes retrieving, by the computer, the second instruction set from the cloud platform based on the determination that the first identifier is different from the second identifier; The computer-implemented method includes updating, by the computer, the application based on the retrieved second instruction set. The updating of the application corresponds to a replacement of the first instruction set within the application with the second instruction set. The computer-implemented method includes outputting, by the computer, the updated application. In the disclosed computer-implemented method, based on the application being hosted on the cloud platform, the method corresponds to outputting the updated application on the cloud platform. Outputting the updated application on the cloud platform may lead to cost-effectiveness as the first instruction set might be complex and may use more computational power resulting in high cost as compared to the second instruction set which may be more optimized. Further, based on the application being hosted on the electronic device, the method corresponds to outputting the updated application on the electronic device, making it more customizable from developer's end.

In various embodiments of the disclosure, the computer-implemented method further includes comparing, by the computer, the first identifier associated with the first instruction set and the second identifier associated with the second instruction set. The first identifier and the second identifier are compared for the analysis of the first identifier and the second identifier. The computer-implemented method further includes determining, by the computer, the first identifier is different from the second identifier based on the comparison. The disclosed computer-implemented method results in improved efficiency as updating the application requires processing power and resource consumption. The method for comparing the first identifier and the second identifier for determining that the first identifier is different from the second identifier results in more optimized utilization of resources as the update of the application only takes place if the first identifier and the second identifier do not match. In a case where the first identifier and the second identifier are compared and are found to be identical, the process of updating the application does not take place.

In various embodiments of the disclosure, the computer-implemented method further includes receiving, by the computer, a notification indicative of a completion of deployment of the second instruction set on the cloud platform. The computer-implemented method further includes retrieving, by the computer, the first identifier associated with the first instruction set based on the received notification. By retrieving identifiers based on notifications, the disclosed computer-implemented method ensures seamless integration and consistency of updating applications across diverse platforms and devices.

In various embodiments of the disclosure, the computer-implemented method further includes retrieving, by the computer, a third identifier associated with the second instruction set. The third identifier is retrieved based on the retrieval of the second instruction set. The third identifier is retrieved from the cloud platform. The computer-implemented method further includes analyzing, by the computer, the second identifier and the third identifier. The computer-implemented method further includes determining, by the computer, the second identifier is different from the third identifier based on the analysis. The computer-implemented method further includes retrieving, by the computer, the second instruction set from the cloud platform based on the determination that the second identifier is different from the third identifier. The computer-implemented method further includes updating, by the computer, the application based on the retrieved second instruction set. In traditional mechanisms, as the update of the application by replacing previous version of code (the first instruction set) with an updated version of code (the second instruction set) was handled manually, there was limited assurance for code integrity. The disclosed computer-implemented method ensures the integrity of the updated code by comparing the hash value of the updated code with the hash value that was received during the initiation of the updating process. Further, the disclosed computer-implemented method eliminates updating the application with incorrect code. As the second identifier is compared with the third identifier, a difference between the second identifier and the third identifier indicates that there is an inconsistency in the updated code. By eliminating updating of the application with incorrect code, the risk of security threats is reduced.

In various embodiments of the disclosure, the computer-implemented method further includes retrieving, by the computer, a fourth identifier associated with a containerized image of the first instruction set. The containerized image of the first instruction set is deployed within the application hosted on the cloud platform. The disclosed computer-implemented method provides retrieval of the hash value (fourth identifier) associated with the containerized image of the first instruction set from a trusted environment that is the cloud platform.

In various embodiments of the disclosure, the computer-implemented method further includes retrieving, by the computer, a fifth identifier associated with a containerized image of the second instruction set. The containerized image of the second instruction set is hosted on the cloud platform. The computer-implemented method further includes analyzing, by the computer, the fourth identifier and the fifth identifier. The computer-implemented method further includes determining, by the computer, the fourth identifier is different from the fifth identifier based on the analysis. The computer-implemented method further includes retrieving, by the computer, the containerized image of the second instruction set from the cloud platform based on the determination that the fourth identifier is different from the fifth identifier. The computer-implemented method further includes updating, by the computer, the application based on the retrieved containerized image of the second instruction set. The updating of the application corresponds to a replacement of the containerized image of the first instruction set within the application with the containerized image of the second instruction set. The computer-implemented method further includes outputting, by the computer, the updated application. In the disclosed computer-implemented method, based on the application being hosted on the cloud platform, the method corresponds to outputting the updated application on the cloud platform. Outputting the updated application on the cloud platform may lead to cost-effectiveness as the containerized image of the first instruction set might be complex and may use more computational power resulting in high cost as compared to the containerized image of the second instruction set which may be more optimized.

In various embodiments of the disclosure, the computer-implemented method further includes retrieving, by the computer, a sixth identifier associated with the containerized image of the second instruction set. The sixth identifier is retrieved based on the retrieval of the containerized image of the second instruction set. The sixth identifier is retrieved from the cloud platform. The computer-implemented method further includes analyzing, by the computer, the fifth identifier and the sixth identifier. The computer-implemented method further includes determining, by the computer, the fifth identifier is different from the sixth identifier based on the analysis. The computer-implemented method further includes updating, by the computer, the application based on the determination. In traditional mechanisms, the update of the application by replacing previous version of a containerized image of the code (the containerized image of the first instruction set) with an updated version of the containerized image of code (the containerized image of the second instruction set) was handled manually, there was limited assurance for the integrity of the updated containerized image of the code. The disclosed computer-implemented method ensures the integrity of the updated containerized image of the code by comparing the hash value of the updated containerized image of the code with the hash value that was received during the initiation of the updating process.

In various embodiments of the disclosure, the computer-implemented method further includes retrieving, by the computer, the containerized image of the second instruction set from the cloud platform based on the determination that the fifth identifier is different from the sixth identifier. The computer-implemented method further includes updating, by the computer, the application based on the retrieved containerized image of the second instruction set. The disclosed computer-implemented method eliminates updating the application with an incorrect containerized image of the code. As the fifth identifier is compared with the sixth identifier, a difference between the fifth identifier and the sixth identifier indicates that there is an inconsistency in the updated containerized image of the code. By eliminating updating the application with incorrect containerized image of the code, the risk of security threats is reduced.

In various embodiments of the disclosure, a computer system for controlling an update of instruction sets within applications using identifiers is described. The computer system includes a processor set, a computer-readable storage media, and program instructions that are stored on the one or more computer-readable storage media. The program instructions are executable by the processor set to cause the processor set to retrieve a first identifier associated with a first instruction set. The first instruction set is deployed within an application hosted on one of a cloud platform or an electronic device. The program instructions further cause the processor set to retrieve a second identifier associated with a second instruction set, the second instruction set is hosted on the cloud platform. The second instruction set is associated with the first instruction set. The program instructions further cause the processor set to analyze the first identifier and the second identifier. The program instructions further cause the processor set to determine the first identifier is different from the second identifier based on the analysis. The program instructions further cause the processor set to retrieve the second instruction set from the cloud platform based on the determination that the first identifier is different from the second identifier. The program instructions further cause the processor set to update the application based on the retrieved second instruction set. The update of the application corresponds to a replacement of the first instruction set within the application with the second instruction set. The program instructions further cause the processor set to output the updated application. The disclosed computer system provides retrieval of the hash value (the second identifier) associated with the second instruction set from a trusted environment that is the cloud platform. In the disclosed computer system, based on the application being hosted on the cloud platform, the method corresponds to outputting the updated application on the cloud platform. Outputting the updated application on the cloud platform may lead to cost-effectiveness as the first instruction set might be complex and may use more computational power resulting in high cost as compared to the second instruction set which may be more optimized.

In various embodiments of the disclosure, the program instructions further cause the processor set to compare the first identifier associated with the first instruction set and the second identifier associated with the second instruction set. The first identifier and the second identifier are compared for the analysis of the first identifier and the second identifier. The program instructions further cause the processor set to determine the first identifier is different from the second identifier based on the comparison. The disclosed computer system results in improved efficiency as updating the application requires processing power and resource consumption. The system determines that the first identifier is different from the second identifier results in more optimized utilization of resources as the update of the application only takes place if the first identifier and the second identifier do not match. This results in better utilization of cloud resources which further results in cost effectiveness. In a scenario, if the disclosed computer system determines that the first identifier is identical to the second identifier, the update does not take place.

In various embodiments of the disclosure, the program instructions further cause the processor set to receive a notification indicative of a completion of deployment of the second instruction set on the cloud platform. The program instructions further cause the processor set to retrieve the first identifier associated with the first instruction set based on the received notification. By retrieving identifiers based on notifications, the disclosed computer-implemented method ensures seamless integration and consistency across different platforms and devices.

In various embodiments of the disclosure, the program instructions further cause the processor set to retrieve a third identifier associated with the containerized image of the second instruction set. The third identifier is retrieved based on the retrieval of the containerized image of the second instruction set. The third identifier is retrieved from the cloud platform. The program instructions further cause the processor set to analyze the second identifier and the third identifier. The program instructions further cause the processor set to determine the second identifier is different from the third identifier based on the analysis. The program instructions further cause the processor set to retrieve the second instruction set from the cloud platform based on the determination that the second identifier is different from the third identifier. The program instructions further cause the processor set to update the application update the application based on the retrieved second instruction set. In traditional mechanisms, as the update of the application by replacing previous version of code (the first instruction set) with an updated version of code (the second instruction set) was handled manually, there was limited assurance for code integrity. The disclosed computer-implemented method ensures the integrity of the updated code by comparing the hash value of the updated code with the hash value that was received during the initiation of the updating process. Further, the disclosed computer-implemented method eliminates updating the application with incorrect code. As the second identifier is compared with the third identifier, a difference between the second identifier and the third identifier indicates that there is an inconsistency in the updated code. By eliminating updating of the application with incorrect code, the risk of security threats is reduced.

In various embodiments of the disclosure, the program instructions further cause the processor set to retrieve a fourth identifier associated with a containerized image of the first instruction set. The containerized image of the first instruction set is deployed within the application hosted on the cloud platform. The disclosed computer system provides retrieval of the hash value (the fourth identifier) associated with the containerized image of the first instruction set from a trusted environment that is the cloud platform.

In various embodiments of the disclosure, the program instructions further cause the processor set to retrieve a fifth identifier associated with a containerized image of the second instruction set. The containerized image of the second instruction set is hosted on the cloud platform. The program instructions further cause the processor set to analyze, the fourth identifier and the fifth identifier. The program instructions further cause the processor set to determine the fourth identifier is different from the fifth identifier based on the analysis. The program instructions further cause the processor set to retrieve the containerized image of the second instruction set from the cloud platform based on the determination that the fourth identifier is different from the fifth identifier. The program instructions further cause the processor set to update the application based on the retrieved containerized image of the second instruction set. The update of the application corresponds to a replacement of the containerized image of the first instruction set within the application with the containerized image of the second instruction set. The program instructions further cause the processor set to output the updated application. In the disclosed computer system, based on the application being hosted on the cloud platform, the system outputs the updated application on the cloud platform. Outputting the updated application on the cloud platform may lead to cost-effectiveness as the containerized image of the first instruction set might be complex and may use more computational power resulting in high cost as compared to the containerized image of the second instruction set which may be more optimized.

In various embodiments of the disclosure, the program instructions further cause the processor set to retrieve a sixth identifier associated with the containerized image of the second instruction set. The sixth identifier is retrieved based on the retrieval of the containerized image of the second instruction set. The sixth identifier is retrieved from the cloud platform. The program instructions further cause the processor set to analyze the fifth identifier and the sixth identifier. The program instructions further cause the processor set to determine the fifth identifier is different from the sixth identifier based on the analysis. The program instructions further cause the processor set to update the application based on the determination. In traditional mechanisms, the update of the application by replacing previous version of a containerized image of the code (the containerized image of the first instruction set) with an updated version of the containerized image of code (the containerized image of the second instruction set) was handled manually, there was limited assurance for the integrity of the updated containerized image of the code. The disclosed computer system ensures the integrity of the updated containerized image of the code by comparing the hash value of the updated containerized image of the code with the hash value that was received during the initiation of the updating process.

In various embodiments of the disclosure, The program instructions further cause the processor set to retrieve the containerized image of the second instruction set from the cloud platform based on the determination that the fifth identifier is different from the sixth identifier. The program instructions further cause the processor set to update the application based on the retrieved containerized image of the second instruction set. The disclosed computer system eliminates updating the application with an incorrect containerized image of the code. As the fifth identifier is compared with the sixth identifier, a difference between the fifth identifier and the sixth identifier indicates that there is an inconsistency in the updated containerized image of the code. By eliminating updating the application with incorrect containerized image of the code, the risk of security threats is reduced.

In various embodiments of the disclosure, a computer program product for controlling the update of the instruction sets within the applications using the identifiers is provided. The computer program product includes a computer-readable storage media having program instructions stored on the computer-readable storage media to perform operations. The operations include retrieving a first identifier associated with a first instruction set. The first instruction set is deployed within an application hosted on one of a cloud platform or an electronic device. The operations further include retrieving a second identifier associated with a second instruction set, the second instruction set is hosted on the cloud platform. The second instruction set is associated with the first instruction set. The operations further include analyzing the first identifier and the second identifier. The operations further include determining the first identifier is identical to the second identifier based on the analysis. The operations further include outputting the application based on the determination that the first identifier is identical to the second identifier. In the disclosed computer program product, based on the application being hosted on the cloud platform, the disclosed computer program product outputs the updated application on the cloud platform. Outputting the updated application on the cloud platform may lead to cost-effectiveness as the first instruction set might be complex and may use more computational power resulting in high cost as compared to the second instruction set which may be more optimized. Further, based on the application being hosted on the electronic device, the disclosed computer program product outputs the updated application on the electronic device, making it more customizable from developer's end.

In various embodiments of the disclosure, the operations further include comparing the first identifier associated with the first instruction set and the second identifier associated with the second instruction set. The first identifier and the second identifier are compared for the analysis of the first identifier and the second identifier. The operations further include determining the first identifier is identical to the second identifier based on the comparison. The disclosed computer program product results in efficient resource utilization, as upon the determination that the first identifier is identical to the second identifier, the operation of updating the application does not occur, resulting in resource utilization as the updating of the application mandates expenditure of resources.

In various embodiments of the disclosure, the operations further include retrieving a third identifier associated with a containerized image of the first instruction set. The containerized image of the first instruction set is deployed within an application hosted on a cloud platform. The operations further include retrieving the fourth identifier associated with a containerized image of the second instruction set, the containerized image of the second instruction set is hosted on the cloud platform. The containerized image of the second instruction set is associated with the containerized image of the first instruction set. The operations further include analyzing the third identifier and the fourth identifier. The operations further include determining the third identifier is identical to the fourth identifier based on the analysis. The operations further include outputting the application based on the determination that the third identifier is identical to the fourth identifier. The disclosed computer program product results in efficient resource utilization, as upon the determination that the third identifier is identical to the fourth identifier, the operation of updating the application with the containerized image of the second instruction set does not occur, resulting in resource utilization as the updating of the application mandates expenditure of resources.

In various embodiments of the disclosure, the first identifier and the second identifier correspond to a first unique string of characters and a second unique string of characters respectively. The first unique string of characters and the second unique string of characters are generated using one or more functions. The one or more functions include at least a hash function. The disclosed computer program product utilizes unique strings of characters associated with the first instruction set and the second instruction set. Further, hash functions that are utilized to generate the first unique string of characters and the second unique string of characters minimize the risk of collisions, ensuring that each update in the instruction set can be accurately identified and retrieved without ambiguity.

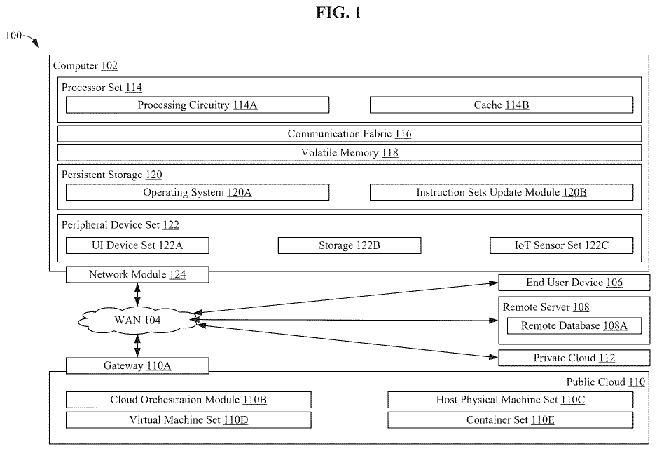

FIG. 1 is a diagram that illustrates a computing environment for controlling an update of instruction sets within applications using identifiers, in accordance with an embodiment of the disclosure. With reference to FIG. 1, there is shown a computing environment 100 that contains an example of an environment for execution of at least some of the computer code involved in performing the inventive methods, such as an instruction sets update module 120B. In addition to the instructions sets update module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the instruction sets update module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any different form of a computer or a mobile device now known or to be developed in the future that is configured to running a program, accessing a network or querying a database, such as a remote database 108A. As is well understood in the art of computer technology, and depending upon the technology, the performance of a computer-implemented method may be distributed among multiple computers and/or between multiple locations. Additionally, in this presentation of the computing environment 100, detailed discussion is focused on a single computer, specifically the computer 102, to keep the presentation as simple as possible. The computer 102 may be located in a cloud, even though it is not shown in a cloud in FIG. 1. Additionally, the computer 102 doesn't have to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the storage media discussed below. The program instructions, and associated data, are accessed by the processor set 114 to control and direct the performance of the methods. In computing environment 100, at least some of the instructions for performing the methods may be stored in the dynamic modification of the instruction sets update module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Different types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not vital unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the instruction sets update module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is mandatory to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and an alternate sensor may be a motion detector.

The network module 124 is the collection of computer software, hardware, and firmware that allows computer 102 to communicate with different computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

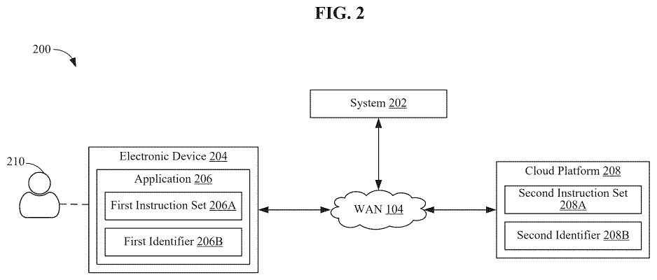

FIG. 2 is a diagram that illustrates an environment for controlling the update of the instruction sets within the applications using the identifiers, in accordance with an embodiment of the disclosure. FIG. 2 is explained in conjunction with elements from FIG. 1. With reference to FIG. 2, there is shown a diagram of a network environment 200. The network environment 200 includes a system 202, an electronic device 204, and a cloud platform 208. There is further shown an application 206 associated with the electronic device 204. The application 206 further includes a first instruction set 206A and a first identifier 206B. The cloud platform 208 further includes a second instruction set 208A and a second identifier 208B. The electronic device 204 is associated with a user 210. The network environment 200 further includes the WAN 104 of FIG. 1. In an embodiment of the disclosure, the system 202 may be an exemplary embodiment of the computer 102 in FIG. 1.

The system 202 may include suitable logic, circuitry, interfaces, and/or code that may be configured for controlling an update of the instruction sets within the applications using the identifiers. The system 202 is configured to retrieve the first identifier 206B associated with the first instruction set 206A. The first instruction set 206A is deployed within the application 206 hosted on one of the cloud platform 208 or the electronic device 204. The system 202 is further configured to retrieve the second identifier 208B associated with the second instruction set 208A, the second instruction set 208A is hosted on the cloud platform 208. The second instruction set 208A is associated with the first instruction set 206A. The system 202 is further configured to analyze the first identifier and the second identifier. Further, the system 202 is configured to determine the first identifier 206B is different from the second identifier 208B based on the analysis. Further, the system 202 is configured to retrieve the second instruction set 208A from the cloud platform 208 based on the determination that the first identifier is different from the second identifier. The system 202 is further configured to update the application 206 based on the retrieved second instruction set 208A. The update of the application 206 corresponds to a replacement of the first instruction set 206A within the application 206 with the second instruction set 208A. In an embodiment, the system 202 can be a computing device, a server, a computer work-station, or a mainframe machine. In an alternate embodiment, based on the determination that the first identifier 206B is identical to the second identifier 208B, the system 202 is configured to output the application 206.

The electronic device 204 may include suitable logic, circuitry, interfaces, and/or code that may be configured to host the application 206. By way of example, and not by limitation, the application 206 includes first instruction set 206A associated with the application 206. In an embodiment, the electronic device 204 may include a display screen. In an embodiment, the user 210 may correspond to a stand-alone user or an organization associated with the application 206 hosted on one of the cloud platform 208, or the electronic device 204. Examples of the electronic device 204 may include, but are not limited to, a computing device, a server, a computer work-station, a smartphone, a cellular phone, a mobile phone, a mainframe machine, a gaming device, a consumer electronic (CE) device, a head-mounted device, a projection-based system, and/or any device with computer vision display capabilities.

The application 206 may be a program or a set of programs designed to perform specific tasks for users. The tasks may range from productivity and communication to entertainment and data management. In an embodiment, the application 206 may be categorized into various types such as, but not limited to, desktop applications, web applications, mobile applications, and enterprise applications. In an embodiment, the desktop applications are installed on personal computers (such as the electronic device 204). Further, the web applications run in web browsers and can be accessed from any device with internet connectivity, offering services such as, but not limited to, online banking, social networking, and e-commerce. Further, the mobile applications are for smartphones and tablets, providing users with instant access to services and features. The enterprise applications are tailored for organizations, facilitating complex business processes and improving operational efficiency.

Modern applications frequently leverage the cloud platform 208, allowing for scalability, flexibility, and remote access. They may also incorporate advanced processes such as artificial intelligence, machine learning, and data analytics to enhance user experience and provide personalized services.

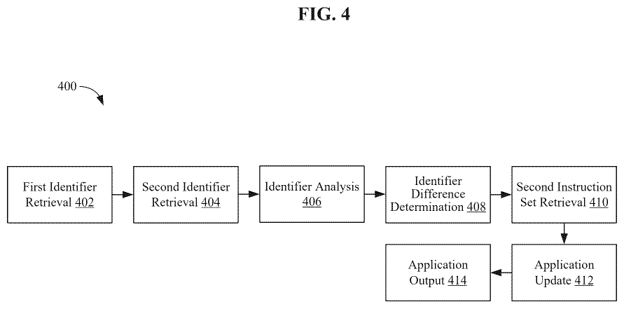

In an embodiment, instruction sets (such as the first instruction set 206A and the second instruction set 208A) may correspond to algorithms such as, but not limited to, security algorithms, Artificial Intelligence (AI) algorithms, or Machine Learning (ML) algorithms. In an embodiment, the first instruction set 206A is associated with the second instruction set 208A. By way of example, and not by limitation, the second instruction set 208A corresponds to an updated version of the first instruction set 206A. Further details about the first instruction set 206A and the second instruction set 208A are provided in FIG. 4

The cloud platform 208 includes suitable logic, circuitry, interfaces, and/or code that may be configured to host the application 206. Generally, the cloud platform 208 is a software framework that enables the deployment, management, and scaling of applications hosted on the cloud platform 208. The cloud platform 208 provides a consistent runtime environment by encapsulating the application 206 and the dependencies of the application 206 within containers, ensuring seamless operation across various computing environments. These platforms offer tools and services for orchestrating containers, optimizing resource utilization, and automating tasks such as scaling and fault tolerance. Examples of different types of the cloud platform 208 include but are not limited to, amazon web services (AWS)®, Microsoft azure®, salesforce®, and container orchestrators (such as Kubernetes®). A person with ordinary skill in the art will understand that the scope of the disclosure may not be limited to the implementation of the cloud platform 208 and the system 202 as two separate entities. In certain embodiments, the functionalities of the cloud platform 208 can be incorporated in its entirety or at least partially in the system 202, without a departure from the scope of the disclosure.

In an embodiment, the first identifier 206B may correspond to a hash value of the first instruction set 206A. Further, the second identifier 208B may correspond to the hash value of the second instruction set 208A. The hash value is a fixed-size string of characters generated by a hash function that may uniquely represent contents of code (such as the first instruction set 206A or the second instruction set 208A) or a specific file. The hash functions are mathematical algorithms that transform input data (such as the first instruction set 206A or the second instruction set 208A) into a fixed-size string of characters. An output of the hash function is the hash value (such as the first identifier 206B or the second identifier 208B).

Various types of hash functions are, but not limited to, Message Digest Algorithm 5 (MD5), Secure Hash Algorithm 1 (SHA-1), and Secure Hash Algorithm 2 (SHA-2). The hash value is constructed to be unique and any modification in the first instruction set 206A may result in the generation of an updated hash value (the second identifier 208B) associated with the updated first instruction set 206A (the second instruction set 208A). The first identifier 206B may be of a fixed length. For example, (Secure Hash Algorithm 256-bit) SHA-256 of the SHA-2 family produces a 256-bit (32-byte) hash value, represented as a 64-character hexadecimal string. The SHA-256 is a cryptographic hash function used for security and efficiency.

In operation, to update the instruction sets within the applications using the identifiers, the system 202 is configured to retrieve the first identifier 206B associated with the first instruction set 206A. The first identifier 206B corresponds to the hash value of the first instruction set 206A. The first instruction set 206A may correspond to an algorithm that is implemented within the application 206. In an embodiment, the application 206 may be hosted on a cloud platform 208. In an alternate embodiment, the application 206 may be hosted on the electronic device 204. In a scenario, if the application is hosted on the cloud platform 208, the system 202 is configured to retrieve the first identifier 206B from the cloud platform 208. In a scenario, if the application 206 is hosted on the electronic device 204, the system 202 is configured to retrieve the first identifier 206B from the electronic device 204.

In an embodiment, the algorithm that may be implemented within the application 206 may correspond to, but is not limited to the security algorithm, the machine learning algorithm, or the Artificial Intelligence (AI) algorithm. In an embodiment, the application 206 may be, for example, but are not limited to, web applications, mobile applications, desktop applications, enterprise applications, and gaming applications.

By way of example, and not by limitation, the application 206 corresponds to the web application (such as an E-commerce) application. Further, the application 206 utilizes the first instruction set 206A which may be the security algorithm to ensure security. Further, with technological developments, the first instruction set 206A becomes outdated, vulnerable, and prone to cyber threats. To maintain security within the application 206 and for the users of the application 206, the first instruction set 206A needs to be updated regularly. To update the first instruction set 206A, the system 202 is configured to retrieve the first identifier 206B associated with the first instruction set 206A.

Further, upon the retrieval of the first identifier 206B, the system 202 is configured to retrieve the second identifier 208B associated with the second instruction set 208A. The second identifier 208B corresponds to the hash value of the second instruction set 208A. In an embodiment, the second instruction set 208A is hosted on the cloud platform 208. The system 202 is configured to retrieve the second identifier 208B from the cloud platform 208. The second instruction set 208A is associated with the first instruction set 206A. In an embodiment, the second instruction set 208A is an updated version of the first instruction set 206A. For example, the application 206 utilizes the security algorithm say “X” and a version of the security algorithm “X” corresponds to “version: 1.0”. Further, over a time period say 6 months, the updated version of the security algorithm “X” that is more secure is available on the cloud platform 208. The updated version of the security algorithm “X” corresponds to “version: 2.0”. In this scenario, “version: 1.0” corresponds to the first instruction set 206A, and “version 2.0” corresponds to the second instruction set 208A.

In an alternate embodiment, the second instruction set 208A is a different and more secure algorithm than the first instruction set 206A. For example, the application 206 utilizes the security algorithm say “X” to ensure security within the application 206 and for the users of the application 206. Further, over a time period say 6 months, a new security algorithm “Y” that is more secure is available on the cloud platform 208. In this scenario, the security algorithm “X” corresponds to the first instruction set 206A, and the security algorithm “Y” corresponds to the second instruction set 208A.

Further, to update the security algorithm within the application 206, the system 202 retrieves the first identifier 206B and the second identifier 208B. Further, upon the retrieval of the first identifier 206B and the second identifier 208B, the system 202 is configured to analyze the retrieved first identifier 206B and the retrieved second identifier 208B. In an embodiment, the system 202 analyzes the first identifier 206B and the second identifier 208B to determine that the first identifier 206B is either different or identical to the second identifier 208B. For example, the first identifier 206B associated with the first instruction set 206A corresponds to “ a7d1ed4143241cfebf6eeed3e7934f6d5e1e55fb37eafeb9dabf8a18c31dce8”. Further, the second identifier 208B associated with the second instruction set 208A corresponds to “ a7d1ed4143241cfebf6eeed3e7934f6d5e1e55fb37eafeb9dabf8a18c31dce8”. In an exemplary embodiment, for the analysis of the first identifier 206B and the second identifier 208B the system 202 is configured to compare the first identifier 206B with the second identifier 208B. Further, upon the analysis, the system 202 determines that the first identifier 206B is different from the second identifier 208B.

Further, based on the determination that the first identifier is different from the second identifier, the system 202 is configured to retrieve the second instruction set 208A from the cloud platform 208. For example, the second instruction set 208A (say security algorithm “X”, “version: 2.0”) corresponds to the updated version of the first instruction set 206A (say security algorithm “X”, “version: 1.0”). The system 202 retrieves the second instruction set 208A from the cloud platform 208.

Further, upon the retrieval of the second instruction set 208A from the cloud platform 208, the system 202 is configured to update the application 206 based on the retrieved second instruction set 208A. In an embodiment, the updating of the application 206 corresponds to the replacement of the first instruction set 206A within the application 206 with the second instruction set 208A. For instance, the system 202 replaces the existing security algorithm “X”, “version 1.0”, with the newly retrieved security algorithm “X”, “version 2.0”. The update may include enhancements such as improved encryption methods, bug fixes, and additional security features that are not present in the first instruction set 206A.

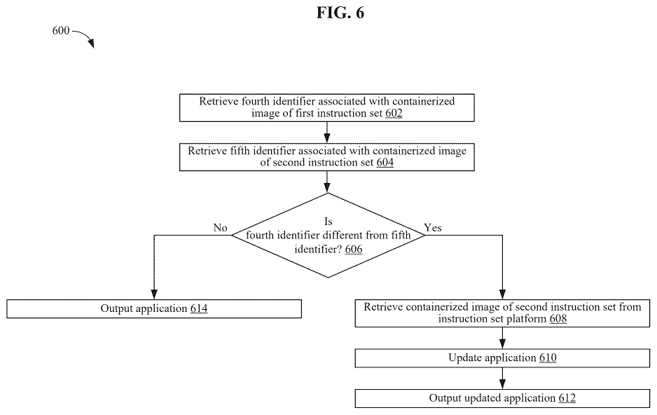

Further, upon updating the application 206 by replacing the first instruction set 206A with the second instruction set 208A, the system 202 is configured to output the updated application 206. In a scenario, if the application 206 is hosted on the electronic device 204, the system 202 is configured to output the updated application 206 on the electronic device 204. In an alternate scenario, if the application 206 is hosted on the cloud platform 208, the system 202 is configured to output the updated application 206 on the cloud platform 208. In a scenario, if the application 206 is hosted on the cloud platform 208, the system 202 updates a containerized image of the first instruction set 206A with the containerized image of the second instruction set 208A. The containerized image of the first instruction set 206A includes code, libraries, and configurations mandatory for the implementation of the security algorithm “X”, and “version 1.0”. Similarly, the containerized image of the second instruction set 208A includes code, libraries, and configurations mandatory for the security algorithm “X”, and “version 2.0”. Details about updating the instruction sets within the application hosted on the cloud platform 208 are provided in FIG. 6.

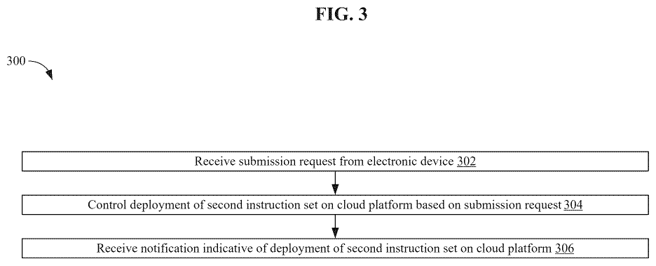

FIG. 3 is a diagram that illustrates a flowchart 300 for controlling deployment of the second instruction set 208A on the cloud platform 208 based on a submission request, in accordance with an embodiment of the disclosure. FIG. 3 is explained in conjunction with elements from FIG. 1, and FIG. 2.

In an embodiment, the application 206 (say an e-commerce application) is hosted on the electronic device 204. The application 206 utilizes a security algorithm to ensure security within the application 206. The security algorithm utilized by the application 206 may correspond to the security algorithm (say first instruction set 206A). Further, the first instruction set 206A is provided to the application 206 by the cloud platform 208. The cloud platform 208 may include various algorithms such as, but not limited to, one or more security algorithms, Artificial Intelligence (AI) algorithms, and Machine Learning (ML) algorithms. In this scenario, the system 202 may provide the security algorithm (the first instruction set 206A) of one or more security algorithms hosted on the cloud platform 208 to the application 206 to ensure security within the application 206. Further, at a first timestamp, the first instruction set 206A is utilized by the application 206. By way of example, and not by limitation, the first instruction set 206A is open-source, indicating source code of the first instruction set 206A is publicly available, allowing users to view, modify, and distribute the first instruction set 206A.

In an embodiment, the user 210 clones the first instruction set 206A on a local machine. Upon cloning the first instruction set 206A, the user 210 who may be an auditor associated with the cloud platform 208 analyses the first instruction set 206A to determine if the first instruction set 206A requires updates. In an alternate embodiment, the system 202 is configured to determine security vulnerabilities within the first instruction set 206A. In an exemplary embodiment, the system 202 is configured to execute various processes to determine the security vulnerabilities within the first instruction set 206A. The various processes may be, but are not limited to, static code analysis, dynamic code analysis, and dependency scanning. Upon the determination of the security vulnerabilities within the first instruction set 206A, the system 202 may notify the user 210 of resolution of the security vulnerability by updating the first instruction set 206A. Further, upon the determination of the security vulnerability within the first instruction set 206A, the system 202 is configured to notify the cloud platform 208 regarding the determination of the security vulnerability within the first instruction set 206A. In an exemplary embodiment, the system 202 sends a notification to the administrator of the cloud platform 208. The administrator of the cloud platform 208 may disable access of the first instruction set 206A to one or more applications that request for access to the first instruction set 206A once the security vulnerability is determined. The updates may be vital within the first instruction set 206A to resolve challenges within the first instruction set 206A. The challenges include but are not limited to, bug fixes, and the security vulnerabilities. Further, upon the determination that the first instruction set 206A requires update, the user 210 makes changes within the first instruction set 206A to update the first instruction set 206A. Upon updating the first instruction set 206A, the user 210 may submit the updated first instruction set 206A to the cloud platform 208. In an example, the updated first instruction set 206A corresponds to the second instruction set 208A.

At 302, the cloud platform 208 may receive a submission request from the electronic device 204. The submission request is indicative of submission of the second instruction set on the cloud platform 208. In an embodiment, the submission request corresponds to a request to commit the second instruction set on the cloud platform 208. The submission request may be initiated by the user 210. In a scenario, the user 210 corresponds to the administrator of the application 206. In an alternate scenario, the user 210 corresponds to an individual with permission to perform updates in the first instruction set 206A hosted on the cloud platform 208. The permission to perform the updates in the second instruction set 208A may be granted by an administrator of the cloud platform 208. The administrator of the cloud platform 208 may be responsible for managing access control, reviewing submission requests, and monitoring updates in the first instruction set 206A.

At 304, the cloud platform 208 may control a deployment of the second instruction set 208A on the cloud platform 208 based on the submission request. By way of example, and not by limitation, upon receiving the submission request from the electronic device 204, an administrator of the cloud platform 208 may analyze the submission request. The administrator of the cloud platform 208 may correspond to an automated administrator. The analysis of the submission request may include performing one or more operations on the second instruction set 208A. The administrator of the cloud platform 208 may execute a first operation corresponding to the review of the second instruction set 208A. In the first operation, the administrator may check for potential issues such as syntax errors, code style violations, and adherence to coding standards within the second instruction set 208A. Further, the administrator of the cloud platform 208 may be configured to execute a second operation on the second instruction set 208A. In the second operation, the administrator of the cloud platform 208 may examine the logic of the second instruction set 208A, structure of the second instruction set 208A, and the overall quality of the second instruction set 208A. In a scenario, if the administrator of the cloud platform 208 identifies based on the second operation that the second instruction set 208A includes logical or structural errors, then the administrator of the cloud platform 208 may provide feedback to the user 210 associated with the electronic device 204 for resolving the identified logical or structural errors.

Further, the administrator of the cloud platform 208 executes a third operation on the second instruction set 208A. In the third operation, the administrator of the cloud platform 208 performs one or more tests on the second instruction set 208A to verify the appropriate working (desired output) of the second instruction set 208A. The one or more tests include, but are not limited to, unit tests, integration tests, and functional tests. Further, upon performing the one or more tests, the administrator of the cloud platform 208 is configured to execute a fourth operation. In the fourth operation, the administrator of the cloud platform 208 performs security analysis of the second instruction set 208A. The administrator of the cloud platform 208 checks for security vulnerabilities within the second instruction set 208A to ensure that implementation of the second instruction set within the application 206 may not expose the application 206 to risks such as, but not limited to injection attacks, or data leaks.

Further, upon performing the security analysis of the second instruction set 208A, the administrator of the cloud platform 208 is configured to execute a fifth operation. In the fifth operation, the administrator of the cloud platform 208 performs a performance evaluation of the second instruction set 208A. The administrator of the cloud platform 208 analyses the second instruction set 208A to ensure that the second instruction set 208A may not degrade speed and efficiency of the application 206. Upon the performance evaluation of the second instruction set 208A, the administrator of the cloud platform 208 is configured to execute a sixth operation. In the sixth operation, the administrator of the cloud platform 208 performs a dependency check on the second instruction set 208A to check for any new dependency introduced by the second instruction set 208A, ensuring that the new dependency is compatible with the application 206. Further, upon the execution of each of the one or more operations associated with the analysis of the second instruction set 208A, the administrator of the cloud platform 208 controls the deployment of the second instruction set 208A on the cloud platform 208. Further, upon the deployment of the second instruction set 208A on the cloud platform 208, the system 202 is configured to enable the access of the second instruction set 208A to the application 206. For example, before the deployment of the second instruction set 208A on the cloud platform 208, the system 202 takes a backup of the first instruction set 206A by storing the first instruction set 206A in a database to allow rollback in case an unsuccessful deployment of the second instruction set 208A.

At 306, the system 202 is configured to receive a notification indicative of the deployment of the second instruction set 208A on the cloud platform 208. By way of example, and not by limitation, upon successful deployment of the second instruction set 208A on the cloud platform 208, the system 202 receives the notification that indicates that the second instruction set 208A is successfully deployed on the cloud platform 208. For example, the notification may correspond to a user interface element (such as a pop-up window) that includes text such as “A new update of the security algorithm is available”. In an embodiment, the electronic device 204 is configured to receive the notification indicative of the deployment of the second instruction set 208A on the cloud platform 208.

FIG. 4 is a block diagram 400 that illustrates one or more operations for controlling the update of the instruction sets within the applications using the identifiers, in accordance with an embodiment of the disclosure. FIG. 4 is explained in conjunction with elements from FIG. 1, FIG. 2, and FIG. 3. With reference to FIG. 4, the operations may start at 402.

At 402, a first identifier retrieval operation is executed. In the first identifier retrieval operation, the system 202 is configured to retrieve the first identifier 206B associated with the first instruction set 206A. The first instruction set 206A is deployed within the application 206 hosted on one of the cloud platform 208 or the electronic device 204. In an embodiment, the system 202 retrieves the first identifier 206B from cloud platform 208. In an alternate embodiment, the system 202 retrieves the first identifier 206B from the electronic device 204. By way of example, and not by limitation, the first identifier 206B corresponds to the hash value associated with the first instruction set 206A.

By way of example, and not by limitation, the application 206 which corresponds to the E-commerce application is hosted on the electronic device 204. The application 206 utilizes the security algorithm hosted on the cloud platform 208 to ensure security within the application 206. The security algorithm corresponds to the first instruction set 206A. Further, the system 202 receives the notification indicative of completion of the deployment of the second instruction set 208A on the cloud platform 208. The reception of the notification indicates that the first instruction set 206A is updated on the cloud platform 208 and the updated first instruction set (the second instruction set 208A) must be implemented within the application 206 to ensure security and protection from vulnerabilities. To perform the implementation of the second instruction set 208A within the application 206, the system 202 receives the first identifier 206B associated with the first instruction set 206A. In a scenario, at the first timestamp, the application 206 uses the first instruction set 206A that corresponds to Data Encryption Standard (DES) for data protection. Details about the DES are omitted for the sake of brevity. The first identifier 206B associated with the first instruction set 206A may be, for example, “6dcd4ce23d88e2ee9568ba546c007c63”. Further, due to security vulnerabilities in the DES, at a second timestamp, DES is updated to Advanced Encryption Standard (AES). The system 202 receives the notification indicative of this update. Upon the reception of the notification, the system 202 retrieves the first identifier 206B associated with the first instruction set 206A (the DES) at a third timestamp. For example, if the application 206 is hosted on the electronic device 204, the system 202 retrieves the first identifier 206B from the memory of the electronic device 204.

At 404, a second identifier retrieval operation is executed. In the second identifier retrieval operation, the system 202 is configured to retrieve the second identifier 208B associated with the second instruction set 208A (say the AES). In an embodiment, the second instruction set 208A is hosted on the cloud platform 208. The AES is an encryption algorithm used to secure data associated with the application 206. By way of example, and not by limitation, the system 202 retrieves the second identifier 208B from the cloud platform 208 at a fourth timestamp. The second identifier 208B associated with the second instruction set 208A may be, for example, “5d41402abc4b2a76b9719d911017c592”. Further, upon the retrieval of the second identifier 208B, the control may pass to 406.

At 406, an identifier analysis operation is executed. In the identifier analysis operation, the system 202 is configured to analyze the first identifier 206B and the second identifier 208B. By way of an example, to analyze the first identifier 206B and the second identifier 208B, the system 202 compares the first identifier 206B and the second identifier 208B. For example, the system 202 compares the first identifier 206B (“6dcd4ce23d88e2ee9568ba546c007c63”) with the second identifier 208B (“5d41402abc4b2a76b9719d911017c592”). Further, upon the analysis of the first identifier 206B and the second identifier 208B, the control may pass to 408.

At 408, an identifier difference determination operation is executed. In the identifier difference determination operation, the system 202 is configured to determine that the first identifier 206B is identical to the second identifier 208B. By way of example, and not by limitation, the system 202 retrieves the first identifier 206B associated with the first instruction set 206A at the third timestamp and the second identifier 208B associated with the second instruction set 208A at the fourth timestamp. Further, the system 202 determines if the first identifier 206B is different from the second identifier 208B. As described in 402, the retrieved first identifier 206B corresponds to the hash value of the first instruction set 206A (the DES) that may be (“6dcd4ce23d88e2ee9568ba546c007c63”). Further, as described in 404, the retrieved second identifier 208B corresponds to the hash value of the second instruction set 208A (the AES) that may be (“5d41402abc4b2a76b9719d911017c592”). Further, at 406, the system 202 is configured to analyze the first identifier 206B and the second identifier 208B compare the first identifier 206B with the second identifier 208B to determine that the first identifier 206B is different from the second identifier 208B. Further, upon the determination that the first identifier 206B is different from the second identifier 208B, the control may pass to 410.

At 410, a second instruction set retrieval operation is executed. In the second instruction set retrieval operation, the system 202 is configured to retrieve the second instruction set 208A from the cloud platform 208 based on the determination that the first identifier 206B is different from the second identifier 208B. The system 202 retrieves the second instruction set 208A from the cloud platform 208 at a fifth timestamp.

By way of example, and not by limitation, the system 202 retrieves the second instruction set 208A from the cloud platform 208. The second instruction set corresponds to the AES. As described in 408, the system 202 determines that the first identifier 206B is different from the second identifier 208B. The difference between the first identifier 206B and the second identifier 208B indicates that the first instruction set 206A is updated and the second instruction set 208A (the updated first instruction set) is deployed on the cloud platform 208. Further, the system 202 receives the notification upon the completion of the deployment of the second instruction set 208A on the cloud platform 208. In a scenario, the system 202 may subscribe to a message queue, where the cloud platform 208 pushes the notification about the deployment of the second instruction set. The system 202 listens for these notifications and retrieves the second instruction set 208A. In an alternate scenario, upon the reception of the notification, the system 202 makes an API call to the cloud platform to fetch the second instruction set 208A, ensuring that system 202 retrieves the second instruction set upon the reception of the notification. Upon the retrieval of the second instruction set 208A, the control may pass to 412.

At 412, an application update operation is executed. In the application update operation, the system 202 is configured to update the application 206 based on the retrieved second instruction set 208A. The update of the application 206 corresponds to the replacement of the first instruction set 206A within the application 206 with the second instruction set 208A.

By way of example, and not by limitation, the system 202 is configured to update the application 206 by replacing the first instruction set 206A within the application 206 with the second instruction set 208A. In a scenario, the system 202 replaces the first instruction set 206A with the second instruction set 208A within a cache memory of the electronic device 204. The cache memory is a high-speed storage area located within the processor of the electronic device 204. The cache memory is configured to temporarily hold frequently accessed data and instructions. In an embodiment, the system 202 may employ various processes to replace the first instruction set 206A with the second instruction set 208A. The various processes may include, but are not limited to, a hot swapping/hot reloading, or code patching,

In an embodiment, the system 202 may be configured to employ the hot swapping/hot reloading process. In the hot swapping/hot reloading process, the system 202 may replace the first instruction set 206A with the second instruction set 208A while the application 206 is in a running state. The system 202 receives the notification associated with the deployment of the second instructions set 208A on the cloud platform and retrieves the first identifier 206B. Further, the system 202 retrieves the second identifier 208B and determines if the first identifier 206B is different from the second identifier 208B. Further, based on the determination that the first identifier 206B is different from the second identifier 208B, the system 202 retrieves the second instruction set 208A and replaces it with the first instruction set 206A within the application 206 in real-time. This process eliminates the need for downtime for the application 206 as the system 202 updates the application 206 dynamically.

In an embodiment, the system 202 may be configured to employ the code patching process. In the code patching process, the system 202 is configured to update the application by applying modifications, known as patches, to the existing codebase of the application 206. The patches may include bug fixes, and fixing security vulnerabilities, without requiring a complete overhaul of the application 206. The user 210 which may be an auditor provides a patch file containing differences between the first instruction set 206A and the second instruction set 208A, allowing the system 202 to apply changes selectively. This process is efficient for maintaining the stability of the application 206 and minimizing downtime of the application 206, as it requires only a restart or refresh of the application 206. Further, upon the successful execution of the updating process of the application 206, the system 202 is configured to replace the first identifier 206B with the second identifier 208B within the application 206. Further, upon updating the application 206, the control may pass to 414.

At 414, an application output operation is executed. In the application output operation, the system 202 is configured to output the updated application. By way of example, and not by limitation, the system 202 is configured to output the updated application on the electronic device 204. In an embodiment, the output of the updated application 206 corresponds to usage of the application 206 with the updated first instruction set 206A (the second instruction set 208A).

For example, if the application is hosted on the cloud platform 208, the system 202 is configured to output the updated application on the cloud platform 208. Details about the application 206 being hosted on the cloud platform are provided in FIG. 6. By way of example, and not by limitation, if the system 202 determines at 408, that the first identifier 206B is identical to the second identifier 208B, then the system 202 is configured to output the application 206 to the electronic device 204. The determination that the first identifier 206B is identical to the second identifier 208B indicates that no updates have been made to the first instruction set 206A that is being utilized by the application 206. For example, if the application is hosted on the cloud platform 208, the system 202 is configured to output the application 206 on the cloud platform 208. Details about the application 206 being hosted on the cloud platform are provided in FIG. 6.

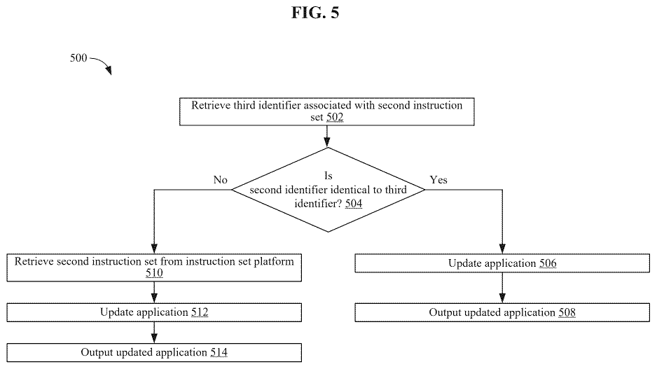

FIG. 5 is a diagram that illustrates a flowchart 500 for updating the application 206 based on the determination of a difference between the second identifier 208B and the third identifier, in accordance with an embodiment of the disclosure. FIG. 5 is explained in conjunction with elements from FIG. 1, FIG. 2, FIG. 3, and FIG. 4.

At 502, the system 202 is configured to retrieve a third identifier associated with the second instruction set 208A. In an embodiment, the third identifier is retrieved based on the retrieval of the second instruction set 208A. Further, the third identifier is retrieved from the cloud platform 208. By way of example, and not by limitation, the third identifier corresponds to the hash value of the second instruction set 208A retrieved at a sixth timestamp. The system 202 is configured to retrieve the third identifier associated with the second instruction set 208A to verify the integrity of the second instruction set 208A before the second instruction set 208A is implemented within the application 206. The implementation of the second instruction set 208A within the application 206 corresponds to replacement of the first instruction set 206A within the application 206 with the second instruction set 208A. In an embodiment, the verification of the integrity of the second instruction set 208A is done to ensure that the second instruction set 208A remains unaltered and executes its functions as intended.

In an example, the third identifier corresponds to the hash value of the second instruction set 208A at the sixth timestamp. The retrieved third identifier may be, for example, but not limited to, “5d41402abc4b2a76b9719d911017c592”. Upon retrieving the third identifier, the control may pass to 504.

At 504, the system 202 is configured to determine that the second identifier 208B associated with the second instruction set 208A is identical to the third identifier associated with the second instruction set 208A. By way of an example, and not by limitation, the system 202 is configured to retrieve the second identifier at the fourth timestamp, and the third identifier at the sixth timestamp. Further, the system 202 is configured to analyze the second identifier 208B and the third identifier by comparing the second identifier 208B with the third identifier to determine that the second identifier is identical to the third identifier.

By way of example, and not by limitation, the second identifier 208B corresponds to “5d41402abc4b2a76b9719d911017c592”. Further, the third identifier corresponds to “5d41402abc4b2a76b9719d911017c592”. Upon the comparison, the system 202 determines that the second identifier 208B is identical to the third identifier. The determination indicates that the second instruction set is not altered between the fourth timestamp and the sixth timestamp further ensuring the integrity of the second instruction set. Further, based on the determination that the second instruction set 208A is identical to the third identifier associated with the second instruction set 208A, the control may pass to 506.

At 506, the system 202 is configured to update the application 206 based on the determination that the second identifier 208B is identical to the third identifier. By way of example, and not by limitation, once the system 202 determines that the second identifier 208B is identical to the third identifier, the system 202 is configured to update the application 206. The system 202 updates the application 206 by replacing the first instruction set 206A with the second instruction set 208A within the application 206. In an embodiment, the system 202 updates the application at a seventh timestamp. For example, if the application 206 is utilizing the first instruction set (the DES) at the first timestamp, the system 202 updates the application 206 and replaces the first instruction set (the DES) with the second instruction set (the AES) at the seventh timestamp. The details of updating the application 206 are provided in FIG. 4. Further, upon updating the application 206, the control may pass to 508.

At 508, the system 202 is configured to output the updated application 206. In an embodiment, the system 202 outputs the updated application 206 on the electronic device 204. In an alternate embodiment, based on the application 206 being hosted on the cloud platform 208, the system 202 updates the application 206 within the cloud platform 208. Further, based on the determination at 504, if the system 202 determines that the second identifier 208B is different from the third identifier, the control may pass to 510.

At 510, the system 202 is configured to retrieve the second instruction set from the cloud platform 208. The system 202 retrieves the second instruction set 208A based on the determination that the second identifier is different from the third identifier. By way of example, and not by limitation, the second identifier 208B retrieved at the fourth timestamp corresponds to “5d41402abc4b2a76b9719d911017c592”. Further, the third identifier retrieved at the sixth timestamp corresponds to “5d41402abc4b2a76b9719d911017c591”. Upon the comparison, the system 202 determines that the second identifier 208B is different from the third identifier. The determination indicates that the second instruction set 208A is altered between the fourth timestamp and the sixth timestamp. In a scenario, the determination that the second instruction set 208A is altered between the fourth timestamp and the sixth timestamp may be due to an update in the second instruction set 208A hosted on the cloud platform 208. In an alternate scenario, the determination that the second instruction set 208A is altered between the fourth timestamp and the sixth timestamp may be due to malicious activity such as, but not limited to, man-in-the-middle attack or code tampering.

In an embodiment, the man-in-the-middle attack occurs when an attacker intercepts and alters communication between two parties (such as the cloud platform 208 and the electronic device 204), often to steal application information or inject malware within the application 206. The attacker positions themselves between the cloud platform 208 and the electronic device 204, modifying code (such as the second instructions set 208A) or injecting malware in real-time, making it appear as if communication is legitimate. Further, the code tampering involves modifying or manipulating the second instruction set 208A without authorization, often to introduce vulnerabilities, backdoors, or malicious functionality within the second instruction set 208A. The tampered second instruction set 208A may compromise the security of the application 206.

Further, upon the determination that the second identifier is different from the third identifier, the system 202 again retrieves the second instruction set 208A hosted on the cloud platform 208 at an eighth timestamp. In an embodiment, the second instruction set 208A retrieved at the eighth timestamp may correspond to an updated version of the second instruction set 208A retrieved at the fifth timestamp. Upon the retrieval of the second instruction set 208A at the eighth timestamp, the control may pass to 512.

At 512, the system 202 is configured to update the application 206 based on the determination that the second identifier 208B is identical to the third identifier. By way of example, and not by limitation, once the system 202 determines that the second identifier 208B is identical to the third identifier, the system 202 is configured to update the application 206. The system 202 updates the application 206 by replacing the first instruction set 206A with the second instruction set 208A within the application 206. In an embodiment, the system 202 updates the application at a seventh timestamp. For example, if the application 206 is utilizing the first instruction set (the DES) at the first timestamp, the system 202 updates the application 206 and replaces the first instruction set (the DES) with the second instruction set (the AES) at the seventh timestamp. The details of updating the application 206 are provided in FIG. 4. Further, upon updating the application 206, the control may pass to 508.

At 514, the system 202 is configured to output the updated application 206. In an embodiment, the system 202 outputs the updated application 206 on the electronic device 204. In an alternate embodiment, based on the application 206 being hosted on the cloud platform 208, the system 202 updates the application 206 within the cloud platform 208.

FIG. 6 is a diagram that illustrates a flowchart for updating the application based on the determination of a difference between a fifth identifier and a sixth identifier, in accordance with an embodiment of the disclosure. FIG. 6 is explained in conjunction with elements from FIG. 1, FIG. 2, FIG. 3, FIG. 4, and FIG. 5.

In an embodiment, the application 206 that may be the E-commerce application is hosted on the cloud platform 208. The application 206 utilizes the containerized image of the first instruction set 206A (say the security algorithm) to protect user data during transactions. When users of the application 206 browse products and proceed to checkout, the application 206 invokes the security algorithm to encrypt sensitive information, such as credit card details. The system 202 allows for seamless updates to the containerized image of the security algorithm, ensuring that the application 206 benefits from the latest security enhancements. For instance, if a new version of the security algorithm is deployed on the cloud platform 208 with improved encryption processes, the system 202 pulls the updated containerized image of the first instruction set 206A (the containerized image of the second instruction set 208A), replaces the containerized image of the first instruction set 206A with the containerized image of the second instruction set 208A.

At 602, the system 202 is configured to retrieve a fourth identifier associated with the containerized image of the first instruction set 206A. The fourth identifier corresponds to the hash value of the containerized image of the first instruction set 206A. By way of example, and not by limitation, once the second instruction set 208A is deployed on the cloud platform 208, the system 202 is configured to generate the containerized image of the second instruction set 208A in the cloud platform 208. The generation of the containerized image of the second instruction set 208A indicates that the containerized image of the security algorithm is updated on the cloud platform 208. Further, to update the containerized image of the security algorithm within the application 206, the system 202 retrieves the fourth identifier. For example, the fourth identifier associated with the containerized image of the first instruction set 206A may correspond to “3f3c1e4b5c8e1e4b5c8e1e4b5c8e1e4b5c8e1e4b5c8e1e4b5c8e1e4b5c8e1e4”. Further, upon the retrieval of the fourth identifier, the control may pass to 604.

At 604, the system 202 is configured to retrieve the fifth identifier associated with the containerized image of the second instruction set 208A. In an embodiment, the containerized image of the second instruction set 208A is hosted on the cloud platform 208. The containerized image of the second instruction set 208A corresponds to the containerized image of the updated security algorithm (say the security algorithm “X”, “version: 2.0”). The fifth identifier corresponds to the hash value of the containerized image of the second instruction set 208A that may be “4f3c1e4b5c8e1e4b5c8e1e4b5c8e1e4b5c8e1e4b5c8e1e4b5c8e1e4b5c8e1e4”. In an embodiment, the system 202 is configured to retrieve the fifth identifier upon the retrieval of the fourth identifier at 602. Further, upon the retrieval of the fifth identifier, the control may pass to 606.

At 606, the system 202 is configured to determine that the fourth identifier is different from the fifth identifier. The system 202 compares the fourth identifier with the fifth identifier to determine that the fourth identifier is different from the fifth identifier. As described in 602, the fourth identifier corresponds to “3f3c1e4b5c8e1e4b5c8e1e4b5c8e1e4b5c8e1e4b5c8e1e4b5c8e1e4b5c8e1e4”. Further, as described in 604, the fifth identifier corresponds to “4f3c1e4b5c8e1e4b5c8e1e4b5c8e1e4b5c8e1e4b5c8e1e4b5c8e1e4b5c8e1e4”. Upon the comparison of the fourth identifier and the fifth identifier, the system 202 determines that the fourth identifier is different from the fifth identifier. The control may pass to 608.

At 608, the system 202 is configured to retrieve the containerized image of the second instruction set 208A from the cloud platform 208 based on the determination that the fourth identifier is different from the fifth identifier. The process of the retrieval of the containerized image of the second instruction set 208A is similar to the process of the retrieval of the second instruction set 208A described in FIG. 4. Further, upon the retrieval of the containerized image of the second instruction set, the control may pass to 610.

At 610, the system 202 is configured to update the application 206 based on the retrieved containerized image of the second instruction set 208A. In an embodiment, the updating of the application 206 corresponds to the replacement of the containerized image of the first instruction set 206A within the application 206 with the containerized image of the second instruction set 208A. In an embodiment, to update the application 206, the system 202 retrieves the containerized image of the second instruction set 208A from the cloud platform 208. Once the containerized image of the second instruction set 208A is available, the system 202 disables the currently running instance of the application 206. After disabling the running instance of the application 206, the system 202 replaces the containerized image of the first instruction set 206A with the containerized image of the second instruction set 208A. Further, once the system 202 successfully replaces the containerized image of the first instruction set 206A with the containerized image of the second instruction set 208A, the system 202 re-enables the application 206 with the containerized image of the second instruction set 208A and outputs the updated application 206 at 612.

In an alternate embodiment, to update the application 206 in real-time with no downtime, the system 202 is configured to employ a rolling update strategy. Initially, the system 202 retrieves the containerized image of the second instruction set 208A while an instance of the application 206 associated with the containerized of the first instruction set 206A is still running. The system 202 starts a new instance of the application 206 associated with the containerized image of the second instruction set 208A alongside the instance of the application 206 associated with the containerized of the first instruction set 206A. As the new instance of the application 206 associated with the containerized image of the second instruction set 208A becomes stable, the system 202 routes traffic to the new instance, allowing for a seamless transition. Finally, the instance of the application 206 associated with the containerized of the first instruction set 206A is terminated, completing the update while maintaining continuous service availability for users of the application 206. Further, upon the successful execution of the updating process of the application 206, the system 202 is configured to replace the fourth identifier with the fifth identifier within the application 206.

By way of example, and not by limitation, if at 614, the system 202 determines, based on the comparison, that the fourth identifier is similar to the fifth identifier, then this may indicate that the containerized image of the second instruction set 208A is similar to the containerized image of the first instruction set 206A, and no update is needed within the application 206. Further, the system 202 is configured to output the application 206 associated with the containerized image of the first instruction set 206A at 614.

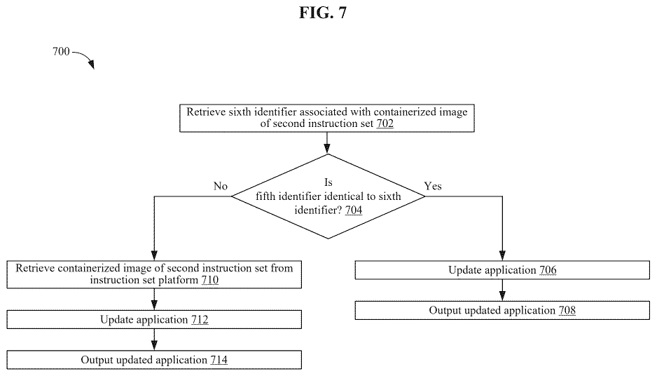

FIG. 7 is a diagram that illustrates a flowchart 700 for updating the application 206 based on the determination of a difference between a fifth identifier and a sixth identifier, in accordance with an embodiment of the disclosure. FIG. 7 is explained in conjunction with elements from FIG. 1, FIG. 2, FIG. 3, FIG. 4, FIG. 5, and FIG. 6.

At 702, the system 202 is configured to retrieve a sixth identifier associated with the containerized image of the second instruction set 208A. In an embodiment, the sixth identifier is retrieved based on the retrieval of the containerized image of the second instruction set 208A. Further, the sixth identifier is retrieved from the cloud platform 208. By way of example, and not by limitation, the sixth identifier corresponds to the hash value of the containerized image of the second instruction set 208A retrieved at a sixth timestamp. The system 202 is configured to retrieve the sixth identifier associated with the containerized image of the second instruction set 208A to verify the integrity of the containerized image of the second instruction set 208A before the containerized image of the second instruction set 208A is implemented within the application 206. The implementation of the containerized image of the second instruction set 208A within the application 206 corresponds to replacement of the containerized image of the first instruction set 206A within the application 206 with the containerized image of the second instruction set 208A. In an embodiment, the verification of the integrity of the containerized image of the second instruction set 208A is done to ensure that the containerized image of the second instruction set 208A remains unaltered and executes its functions as intended.

In an example, the sixth identifier corresponds to the hash value of the containerized image of the second instruction set at the sixth timestamp. The retrieved sixth identifier may be, for example, but not limited to, “5d41402abc4b2a76b9719d911017c592”. Upon retrieving the sixth identifier, the control may pass to 704.

At 704, the system 202 is configured to determine that the fifth identifier associated with the containerized image of the second instruction set 208A is identical to the sixth identifier associated with the containerized image of the second instruction set 208A. By way of an example, and not by limitation, the system 202 is configured to retrieve the fifth identifier at the fourth timestamp, and the sixth identifier at the sixth timestamp. Further, the system 202 is configured to compare the fifth identifier with the sixth identifier to determine that the fifth identifier is identical to the sixth identifier.

By way of example, and not by limitation, the fifth identifier corresponds to “5d41402abc4b2a76b9719d911017c592”. Further, the sixth identifier corresponds to “5d41402abc4b2a76b9719d911017c592”. Upon the comparison, the system 202 determines that the fifth identifier is identical to the sixth identifier. The determination indicates that the containerized image of the second instruction set 208A is not altered between the fourth timestamp and the sixth timestamp further ensuring the integrity of the containerized image of the second instruction set 208A. Further, based on the determination that the fifth identifier is identical to the sixth identifier associated with the containerized image of the second instruction set 208A, the control may pass to 706.

At 706, the system 202 is configured to update the application 206 based on the determination that the fifth identifier is identical to the sixth identifier. By way of example, and not by limitation, once the system 202 determines that the fifth identifier is identical to the sixth identifier, the system 202 is configured to update the application 206. The system 202 updates the application 206 by replacing the containerized image of the first instruction set 206A with the containerized image of the second instruction set 208A within the application 206. In an embodiment, the system 202 updates the application 206 at a seventh timestamp. For example, if the application 206 is utilizing the containerized image of the first instruction set 206A (the DES) at the first timestamp, the system 202 updates the application 206 and replaces the containerized image of the first instruction set 206A (the DES) with the containerized image of the second instruction set 208A (the AES) at the seventh timestamp. Further, upon updating the application 206, the control may pass to 708.

At 708, the system 202 is configured to output the updated application 206. In an embodiment, the system 202 outputs the updated application 206 on the cloud platform 208. Further, based on the determination at 704, if the system 202 determines that the fifth identifier is different from the sixth identifier, the control may pass to 710.

At 710, the system 202 is configured to retrieve the containerized image of the second instruction set from the cloud platform 208. The system 202 retrieves the containerized image of the second instruction set based on the determination that the fifth identifier is different from the sixth identifier. By way of example, and not by limitation, the fifth identifier retrieved at the fourth timestamp corresponds to “5d41402abc4b2a76b9719d911017c592”. Further, the sixth identifier retrieved at the sixth timestamp corresponds to “5d41402abc4b2a76b9719d911017c591”. Upon the comparison, the system 202 determines that the fifth identifier is different from the sixth identifier. The determination indicates that the containerized image of the second instruction set 208A is altered between the fourth timestamp and the sixth timestamp. In a scenario, the determination that the containerized image of the second instruction set 208A is altered between the fourth timestamp and the sixth timestamp may be due to an update in the containerized image of the second instruction set 208A hosted on the cloud platform 208. In an alternate scenario, the determination that the containerized image of the second instruction set 208A is altered between the fourth timestamp and the sixth timestamp may be due to malicious activity such as, but not limited to, the man-in-the-middle attack, or the code tampering. Details about the man-in-the-middle attack and the code tampering are provided in FIG. 5.

Further, upon the determination that the fifth identifier is different from the sixth identifier, the system 202 retrieves the containerized image of the second instruction set 208A hosted on the cloud platform 208 at an eighth timestamp. Upon the retrieval of the containerized image of the second instruction set 208A at the eighth timestamp, the control may pass to 712.

At 712, the system 202 is configured to update the application 206 based on the determination that the fifth identifier is identical to the sixth identifier. By way of example, and not by limitation, once the system 202 determines that the fifth identifier is identical to the sixth identifier, the system 202 is configured to update the application 206. The system 202 updates the application 206 by replacing the containerized image of the first instruction set 206A with the containerized image of the second instruction set 208A within the application 206. In an embodiment, the system 202 updates the application 206. For an example, if the application 206 is utilizing the containerized image of the first instruction set (the DES) at the first timestamp, the system 202 updates the application 206 and replaces the containerized image of the first instruction set (the DES) with the containerized image of the second instruction set (the AES). Further, upon updating the application 206, the system 202 is configured to output the updated application 206 at 714. In an embodiment, the system 202 outputs the updated application 206 on the cloud platform 208.

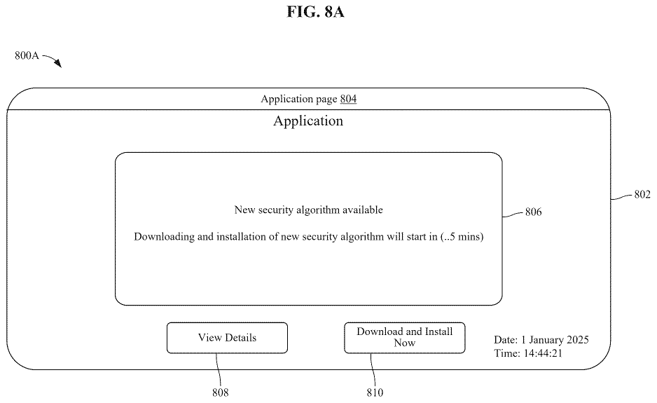

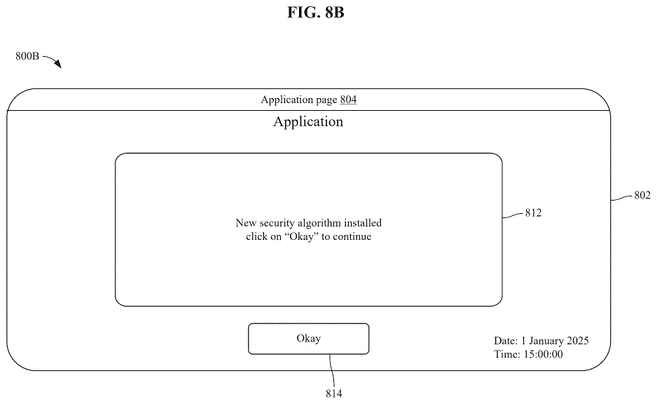

FIG. 8A is a diagram that illustrates an exemplary first user interface for controlling the update of the instruction sets within the applications using the identifiers, in accordance with an embodiment of the disclosure. FIG. 8A is explained in conjunction with elements of FIG. 1, FIG. 2, FIG. 3, FIG. 4, FIG. 5, FIG. 6, and FIG. 7. With reference to FIG. 8A, there is shown an exemplary diagram 800A that includes an electronic device 802 and an application page 804. The application page 804 includes a first user interface (UI) element 806, a second UI element 808, and a third UI element 810.

With reference to FIG. 8A, the system 202 renders the application page 804 on the user interface (UI) of the electronic device 802. The electronic device 702 may be an example of electronic device 204 explained in FIG. 2. In an embodiment, the electronic device 802 is accessed by the user 210 who may be the administrator of the application 206. The electronic device 802 may host the application 206. Further, the system 202 may render the application page 804 on the electronic device 204. The application page 804 may include the first UI element 806. By way of example, and not by limitation, the first UI element 806 corresponds to a notification box. The notification box displays the notifications that occur upon the deployment of the second instruction set 208A on the cloud platform 208. Further, the first UI element 806 may render the notification in the form of text. The text may correspond to for example, “New security algorithm available, Downloading and Installation of new security algorithm will start in ( . . . 5 mins)”

Further, the application page 804 includes the second UI element 808. The second UI element 808 corresponds to a button labeled “view details”. As shown in FIG. 8A, the first UI element 806 renders the notification associated with an update in the security algorithm. The user 210 may click on the second UI element 808 to view details associated with the new update of the security algorithm. By clicking on the second UI element, the user 210 may be able to access the amount of time the update is going to take (for example, 10 mins), a version of the updated security algorithm (for example, the AES), and potential impacts of the updated security algorithm on the application 206.

Further, the application page 804 includes the third UI element 810. The third UI element 810 corresponds to a button labeled “Download and Install Now”. By way of example, and not by limitation, as shown in FIG. 8A, an automatic download process is scheduled in 5 minutes after reception of the notification. Further, the user 210 can click on the third UI element 810 if the user 210 wants to update the security algorithm instantly.

FIG. 8B is a diagram that illustrates an exemplary second user interface for controlling the update of the instruction sets within the applications using the identifiers, in accordance with an embodiment of the disclosure. FIG. 8B is explained in conjunction with elements of FIG. 1, FIG. 2, FIG. 3, FIG. 4, FIG. 5, FIG. 6, FIG. 7, and FIG. 8A. With reference to FIG. 8B, there is shown an exemplary diagram 800B that includes the electronic device 802 and an application page 804. The application page 804 includes a fourth user interface (UI) element 812, and a fifth UI element 814.

With reference to FIG. 8B, the system 202 renders the application page 804 on the user interface (UI) of the electronic device 802. The electronic device 802 may be an example of electronic device 204 explained in FIG. 2. In an embodiment, the electronic device 802 is accessed by the user 210 who may be the administrator of the application 206. Further, the application page 804 may include the fourth UI element 812. By way of example, and not by limitation, the fourth UI element 812 corresponds to the notification box. The notification box displays the notifications that occur upon completion of the downloading and installation process of the second instruction set 208A. Further, the fourth UI element 812 may render the notification in the form of text. The text may correspond to for example, “New Security Algorithm Installed. Click on “Okay” to continue”

Further, the application page 804 includes the fifth UI element 814. The fifth UI element 814 corresponds to a button labeled “okay”. As shown in FIG. 8A, the first UI element 806 popped up at a timestamp that corresponds to (Date: 1 Jan. 2025, Time: 14:44:21). In case of the automatic download process, the downloading and installation of the updated security algorithm may have started at 14:49:21. Further, as described in FIG. 8A, upon clicking on the second UI element 808, the user 210 views the amount of time that will be taken for the update and installation of the security algorithm (for example, 10 minutes). Further, the system 202 may successfully update the security algorithm at a timestamp that corresponds to for example, (Date: 1 Jan., 2025, Time: 15:00:00). Upon the successful completion of the updating of the security algorithm, the user 210 may click on the fifth UI element 814.

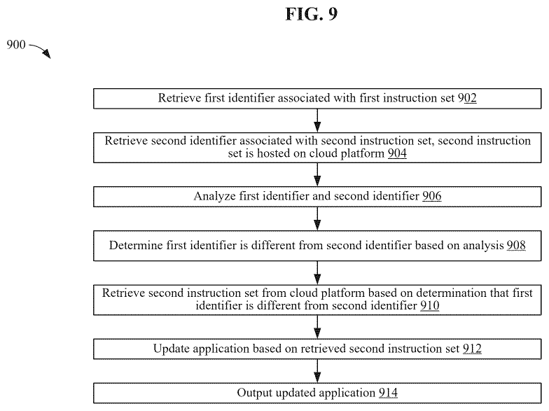

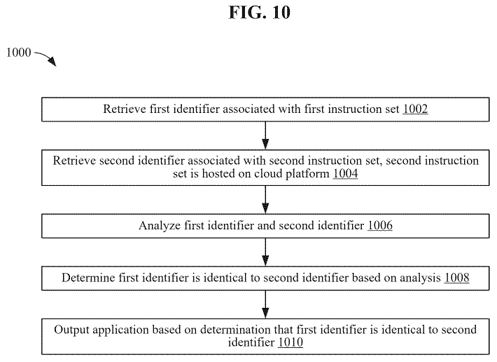

FIG. 9 illustrates a flowchart 900 of a first exemplary method for controlling the update of the instruction sets within the applications using the identifiers, in accordance with an embodiment of the disclosure. FIG. 9 is explained in conjunction with elements of FIG. 1, FIG. 2, FIG. 3, FIG. 4, FIG. 5, FIG. 6, FIG. 7, FIG. 8A and FIG. 8B. With reference to FIG. 10, there is shown the flowchart 900. The operations of the exemplary method may be executed by any computing system, for example, by the computer 102 of FIG. 1 or the system 202 of FIG. 2. The operations of the flowchart 900 may start at 902.

At 902, the first identifier 206B associated with the first instruction set 206A is retrieved. The first instruction set 206A is deployed within the application 206 hosted on one of the cloud platform 208 or the electronic device 204. In an embodiment, the system 202 is configured to retrieve the first identifier 206B associated with the first instruction set 206A. The first instruction set 206A is deployed within the application 206 hosted on one of the cloud platform 208 or the electronic device 204.

At 904, the second identifier 208B associated with the second instruction set 208A is retrieved. The second instruction set 208A is hosted on the cloud platform 208. The second instruction set 208A is associated with the first instruction set 206A. In an embodiment, the system 202 is configured to retrieve the second identifier 208B associated with the second instruction set 208A. The second instruction set 208A is hosted on the cloud platform 208. The second instruction set 208A is associated with the first instruction set 206A.

At 906, the first identifier 206B and the second identifier 208B are analyzed. In an embodiment, the system 202 is configured to analyze the first identifier 206B and the second identifier 208B.

At 908, it is determined that the first identifier 206B is different from the second identifier 208B based on the analysis. In an embodiment, the system 202 is configured to determine the first identifier 206B is different from the second identifier 208B based on the analysis.

At 910, the second instruction set 208A is retrieved from the cloud platform 208 based on the determination that the first identifier 206B is different from the second identifier 208B. In an embodiment, the system 202 is configured to retrieve the second instruction set 208A from the cloud platform 208 based on the determination that first identifier 206B is different from second identifier 208B.

At 912, the application 206 is updated based on the retrieved second instruction set 208A. The update of the application 206 corresponds to the replacement of the first instruction set 206A within the application 206 with the second instruction set 208A. In an embodiment, the system 202 is configured to update the application 206 based on the retrieved second instruction set 208A. The update of the application 206 corresponds to the replacement of the first instruction set 206A within the application 206 with the second instruction set 208A.

At 914, the updated application is outputted. In an embodiment, the system 202 is configured to output the updated application.

FIG. 10 illustrates a flowchart 1000 of a second exemplary method for controlling the update of the instruction sets within the applications using the identifiers, in accordance with an embodiment of the disclosure. FIG. 10 is explained in conjunction with elements of FIG. 1, FIG. 2, FIG. 3, FIG. 4, FIG. 5, FIG. 6, FIG. 7, FIG. 8A, FIG. 8B, and FIG. 9. With reference to FIG. 10, there is shown the flowchart 1000. The operations of the exemplary method may be executed by any computing system, for example, by the computer 102 of FIG. 1 or the system 202 of FIG. 2. The operations of the flowchart 1000 may start at 1002.

At 1002, the first identifier associated with the containerized image of the first instruction set 206A is retrieved. The containerized image of the first instruction set 206A is deployed within the application 206 hosted on a cloud platform 208. In an embodiment, the system 202 is configured to retrieve the first identifier associated with the containerized image of the first instruction set 206A. The containerized image of the first instruction set 206A is deployed within the application 206 hosted on a cloud platform 208.

At 1004, the second identifier associated with the containerized image of the second instruction set 208A is retrieved. The containerized image of the second instruction set 208A is hosted on the cloud platform 208. The containerized image of the second instruction set 208A is associated with the containerized image of the first instruction set 206A. In an embodiment, the system 202 is configured to retrieve the second identifier associated with the containerized image of the second instruction set 208A. The containerized image of the second instruction set 208A is hosted on the cloud platform 208. The containerized image of the second instruction set 208A is associated with the containerized image of the first instruction set 206A.

At 1006, the first identifier and the second identifier are analyzed. In an embodiment, the system 202 is configured to analyze the first identifier and the second identifier.

At 1008, it is determined that the first identifier 206B is identical to the second identifier 208B based on the analysis. In an embodiment, the system 202 is configured to determine that the first identifier is identical to the second identifier based on the analysis.

At 1010, the application 206 is outputted based on the determination that the first identifier 206B is identical to the second identifier 208B. In an embodiment, the system 202 is configured to output the application 206 based on the determination that the first identifier 206B is identical to the second identifier 208B.

In various embodiments of the disclosure, a computer program product for controlling the update of the instruction sets within the applications using the identifiers is provided. The computer program product includes a computer-readable storage media having program instructions stored on the computer-readable storage media to perform operations. The operations include retrieving a first identifier associated with a first instruction set. The first instruction set is deployed within an application hosted on one of a cloud platform or an electronic device. The operations further include retrieving a second identifier associated with a second instruction set, the second instruction set is hosted on the cloud platform. The second instruction set is associated with the first instruction set. The operations further include analyzing the first identifier and the second identifier. The operations further include determining the first identifier is identical to the second identifier based on the analysis. The operations further include outputting the application based on the determination that the first identifier is identical to the second identifier.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
retrieving, by a computer, a first identifier associated with a first instruction set, wherein the first instruction set is deployed within an application hosted on one of a cloud platform or an electronic device;
retrieving, by the computer, a second identifier associated with a second instruction set, the second instruction set is hosted on the cloud platform, wherein the second instruction set is associated with the first instruction set;
analyzing, by the computer, the first identifier and the second identifier;
determining, by the computer, the first identifier is different from the second identifier based on the analysis;
retrieving, by the computer, the second instruction set from the cloud platform based on the determination that the first identifier is different from the second identifier;
updating, by the computer, the application based on the retrieved second instruction set, wherein the updating of the application corresponds to a replacement of the first instruction set within the application with the second instruction set; and
outputting, by the computer, the updated application.

2. The computer-implemented method of claim 1, further comprising:
comparing, by the computer, the first identifier associated with the first instruction set and the second identifier associated with the second instruction set, wherein the first identifier and the second identifier are compared for the analysis of the first identifier and the second identifier; and
determining, by the computer, the first identifier is different from the second identifier based on the comparison.

3. The computer-implemented method of claim 1, further comprising:
receiving, by the computer, a notification indicative of a completion of deployment of the second instruction set on the cloud platform; and
retrieving, by the computer, the first identifier associated with the first instruction set based on the received notification.

4. The computer-implemented method of claim 1, further comprising:
retrieving, by the computer, a third identifier associated with the second instruction set, wherein the third identifier is retrieved based on the retrieval of the second instruction set, and wherein the third identifier is retrieved from the cloud platform;
analyzing, by the computer, the second identifier and the third identifier;
determining, by the computer, the second identifier is different from the third identifier based on the analysis;
retrieving, by the computer, the second instruction set from the cloud platform based on the determination that the second identifier is different from the third identifier; and
updating, by the computer, the application based on the retrieved second instruction set.

5. The computer-implemented method of claim 1, further comprising retrieving, by the computer, a fourth identifier associated with a containerized image of the first instruction set, wherein the containerized image of the first instruction set is deployed within the application hosted on the cloud platform.

6. The computer-implemented method of claim 5, further comprising:
retrieving, by the computer, a fifth identifier associated with a containerized image of the second instruction set, wherein the containerized image of the second instruction set is hosted on the cloud platform;
analyzing, by the computer, the fourth identifier and the fifth identifier;
determining, by the computer, the fourth identifier is different from the fifth identifier based on the analysis;
retrieving, by the computer, the containerized image of the second instruction set from the cloud platform based on the determination that the fourth identifier is different from the fifth identifier;
updating, by the computer, the application based on the retrieved containerized image of the second instruction set, wherein the updating of the application corresponds to a replacement of the containerized image of the first instruction set within the application with the containerized image of the second instruction set; and
outputting, by the computer, the updated application.

7. The computer-implemented method of claim 6, further comprising:
retrieving, by the computer, a sixth identifier associated with the containerized image of the second instruction set, wherein the sixth identifier is retrieved based on the retrieval of the containerized image of the second instruction set, and wherein the sixth identifier is retrieved from the cloud platform;
analyzing, by the computer, the fifth identifier and the sixth identifier;
determining, by the computer, the fifth identifier is different from the sixth identifier based on the analysis; and
updating, by the computer, the application based on the determination.

8. The computer-implemented method of claim 7, further comprising:
retrieving, by the computer, the containerized image of the second instruction set from the cloud platform based on the determination that the fifth identifier is different from the sixth identifier; and
updating, by the computer, the application based on the retrieved containerized image of the second instruction set.

9. A computer system, comprising:
a processor set;
one or more computer-readable storage media; and
program instructions stored on the one or more computer-readable storage media, the program instructions executable by the processor set to cause the processor set to:
retrieve a first identifier associated with a first instruction set, wherein the first instruction set is deployed within an application hosted on one of a cloud platform or an electronic device;
retrieve a second identifier associated with a second instruction set, the second instruction set is hosted on the cloud platform, wherein the second instruction set is associated with the first instruction set;
analyze the first identifier and the second identifier;
determine the first identifier is different from the second identifier based on the analysis;
retrieve the second instruction set from the cloud platform based on the determination that the first identifier is different from the second identifier;
update the application based on the retrieved second instruction set, wherein the update of the application corresponds to a replacement of the first instruction set within the application with the second instruction set; and
output the updated application.

10. The computer system of claim 9, wherein the program instructions further cause the processor set to:
compare the first identifier associated with the first instruction set and the second identifier associated with the second instruction set, wherein the first identifier and the second identifier are compared for the analysis of the first identifier and the second identifier; and
determine the first identifier is different from the second identifier based on the comparison.

11. The computer system of claim 9, wherein the program instructions further cause the processor set to:
receive a notification indicative of a completion of deployment of the second instruction set on the cloud platform; and
retrieve the first identifier associated with the first instruction set based on the received notification.

12. The computer system of claim 9, wherein the program instructions further cause the processor set to:
retrieve a third identifier associated with the second instruction set, wherein the third identifier is retrieved based on the retrieval of the second instruction set, and wherein the third identifier is retrieved from the cloud platform;
analyze the second identifier and the third identifier;
determine the second identifier is different from the third identifier based on the analysis; and
retrieve the second instruction set from the cloud platform based on the determination that the second identifier is different from the third identifier; and
update the application based on the retrieved second instruction set.

13. The computer system of claim 9, wherein the program instructions further cause the processor set to retrieve a fourth identifier associated with a containerized image of the first instruction set, wherein the containerized image of the first instruction set is deployed within the application hosted on the cloud platform.

14. The computer system of claim 13, wherein the program instructions further cause the processor set to:
retrieve a fifth identifier associated with a containerized image of the second instruction set, wherein the containerized image of the second instruction set is hosted on the cloud platform;
analyze the fourth identifier and the fifth identifier;
determine the fourth identifier is different from the fifth identifier based on the analysis;
retrieve the containerized image of the second instruction set from the cloud platform based on the determination that the fourth identifier is different from the fifth identifier;
update the application based on the retrieved containerized image of the second instruction set, wherein the update of the application corresponds to a replacement of the containerized image of the first instruction set within the application with the containerized image of the second instruction set; and
output the updated application.

15. The computer system of claim 14, wherein the program instructions further cause the processor set to:
retrieve a sixth identifier associated with the containerized image of the second instruction set, wherein the sixth identifier is retrieved based on the retrieval of the containerized image of the second instruction set, and wherein the sixth identifier is retrieved from the cloud platform;
analyze the fifth identifier and the sixth identifier;
determine the fifth identifier is different from the sixth identifier based on the analysis; and
update the application based on the determination that the fifth identifier is different from the sixth identifier.

16. The computer system of claim 15, wherein the program instructions further cause the processor set to:
retrieve the containerized image of the second instruction set from the cloud platform based on the determination that the fifth identifier is different from the sixth identifier; and
update the application based on the retrieved containerized image of the second instruction set.

17. A computer program product for controlling an update of a first instruction set within an application, the computer program product comprising:
one or more computer-readable storage media; and
program instructions stored on the one or more computer-readable storage media to perform operations comprising:
retrieving a first identifier associated with the first instruction set, wherein the first instruction set is deployed within the application hosted on one of a cloud platform or an electronic device;
retrieving a second identifier associated with a second instruction set, the second instruction set is hosted on the cloud platform, wherein the second instruction set is associated with the first instruction set;
analyzing the first identifier and the second identifier;
determining the first identifier is identical to the second identifier based on the analysis; and
outputting the application based on the determination that the first identifier is identical to the second identifier.

18. The computer program product of claim 17, wherein the program instructions stored on the one or more computer-readable storage media perform the operations further comprising:
comparing the first identifier associated with the first instruction set and the second identifier associated with the second instruction set, wherein the first identifier and the second identifier are compared for the analysis of the first identifier and the second identifier; and
determining the first identifier is identical to the second identifier based on the comparison.

19. The computer program product of claim 17, wherein the program instructions stored on the one or more computer-readable storage media perform the operations further comprising:
retrieving a third identifier associated with a containerized image of the first instruction set, wherein the containerized image of the first instruction set is deployed within an application hosted on a cloud platform;
retrieving a fourth identifier associated with a containerized image of the second instruction set, the containerized image of the second instruction set is hosted on the cloud platform, wherein the containerized image of the second instruction set is associated with the containerized image of the first instruction set;
analyzing the third identifier and the fourth identifier;
determining the third identifier is identical to the fourth identifier based on the analysis; and
outputting the application based on the determination that the third identifier is identical to the fourth identifier.

20. The computer program product of claim 17, wherein the first identifier and the second identifier correspond to a first unique string of characters and a second unique string of characters respectively, wherein the first unique string of characters and the second unique string of characters are generated using one or more functions, and wherein the one or more functions comprises at least a hash function.
